(19) United States
(12) Patent Application Publication
(10) Pub. No.: US 2012/0253917 A1
(43) Pub. Date: Oct. 4, 2012

(54) METHOD AND APPARATUS FOR MANAGING AND PROVIDING USER PURCHASE INFORMATION

(75) Inventors: Ho-Sik Cho, Suwon-si (KR); Cheol-Ju Hwang, Yongin-si (KR)

(73) Assignee: SAMSUNG ELECTRONICS CO., LTD, Suwon-si (KR)

(21) Appl. No.: 13/355,375

(22) Filed: Jan. 20, 2012

(30) Foreign Application Priority Data
Mar. 28, 2011 (KR) 10-2011-0027560

(51) Int. Cl. G06Q 30/02; G06Q 30/06

(52) U.S. Cl. 705/14.39; 705/26.1; 705/26.9; 705/26.62

(57) ABSTRACT

A method of managing user purchase information includes parsing information related to a product from a user uploaded data, comparing the parsed information with a purchase data of the product by the user, and linking an indicator to the user uploaded data according to the comparison and a method of providing user purchase data in user equipment. The method also includes purchasing and paying for a product with the user equipment, and posting payment information about the product on a social networking service (SNS).

### CROSS-REFERENCE TO RELATED APPLICATION(S) AND CLAIM OF PRIORITY

The present application is related to and claims the benefit of Korean Patent Application No. 10-2011-0027560, filed on Mar. 28, 2011, in the Korean Intellectual Property Office, the disclosure of which is incorporated herein in its entirety by reference.

### TECHNICAL FIELD OF THE INVENTION

The present invention generally relates to information processing systems, and more particularly, to a method and apparatus for managing and providing user purchase information.

### BACKGROUND OF THE INVENTION

Electronic business (e-business) through online shopping malls has been growing at a rate of approximately 15% a year. Such electronic business is advantageous in that almost anybody is capable of launching his/her own online shopping mall without much difficulty. On the other hand, competition in the online shopping mall business is getting quite fierce because of low barriers to entry. Therefore, public relations (PR) is considered the key to success in the online shopping mall businesses. One PR method is a marketing method that utilizes product reviews. However, there is a problem in that there may not be a sufficient number of reviewers for a corresponding product and the trustworthiness of their reviews may not be guaranteed.

### SUMMARY OF THE INVENTION

To address the above-discussed deficiencies of the prior art, it is a primary object to provide an efficient online shopping system and method for both business people and purchasers of commerce on online shopping malls.

According to an aspect of the present invention, there is provided a method of managing user purchase information that includes extracting information related to a product from a user uploaded data, comparing the extracted information with a purchase data of the product by the user, and linking an indicator to the user uploaded data according to the comparison.

The purchase information associated with the product may comprise payment information associated with the product.

The payment information may include at least one of information associated with a purchaser, a purchased product, a purchase price, and a location where the product is purchased.

The method may further include storing the purchase information about the product, which was posted by an external device.

The external device may include user equipment that is used to purchase the product.

The external device may include a server associated with a payment means that is used to purchase the product.

The external device may include a server associated with a location where the product was purchased.

The user uploaded data may include data uploaded onto a social network service (SNS) in which the user is a member.

The linking of the indicator to the user uploaded data based on the result of the comparing may include linking an interface related to purchasing the product to the user uploaded data if the information related to the product corresponds to the purchase information about the product.

The linking of the interface related to purchasing the product to the user uploaded data may include displaying the posted purchase information associated with the product.

The linking of the interface related to purchasing the product to the user uploaded data may include linking an interface for searching for the posted purchase information associated with the product to the user uploaded data.

The method may further include providing an incentive to a user who user uploaded data to be linked to the indicator if another user purchases the product using the indicator.

According to another aspect of the present invention, there is provided a method of providing user purchase data in a user equipment that includes purchasing and paying for a product with the user equipment, and posting payment information about the product on a social networking service (SNS).

The payment information associated with the product may include at least one of information associated with a purchaser, a purchased product, a purchase price, and a location where the product is purchased.

The method may further include receiving reward information from an external device if another user purchases the product based on the payment information.

According to another aspect of the present invention, there is provided an apparatus for managing user purchase information that includes a storage unit for storing purchase information associated with a product, and a control unit for extracting information related to the product from a user uploaded data, comparing the extracted information with a purchase data of the product by the user, and linking an indicator to the user uploaded data according to the comparison.

According to another aspect of the present invention, there is provided an apparatus for providing user purchase data in user equipment that includes a payment unit for purchasing and paying for a product with the user equipment, and a payment information posting unit for posting payment information about the product on a social networking service (SNS).

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart of a method of managing user purchase information, according to an embodiment of the present invention;

FIG. 2 is a flowchart of a method of managing user purchase information, according to another embodiment of the present invention;

FIG. 3 illustrates an interface related to purchase information about a product, according to an embodiment of the present invention;

FIG. 4 is a flowchart of a method of providing user purchase information, according to an embodiment of the present invention; and

FIG. 5 is a block diagram of a system for managing user purchase information, according to an embodiment of the present invention.

### DETAILED DESCRIPTION OF THE INVENTION

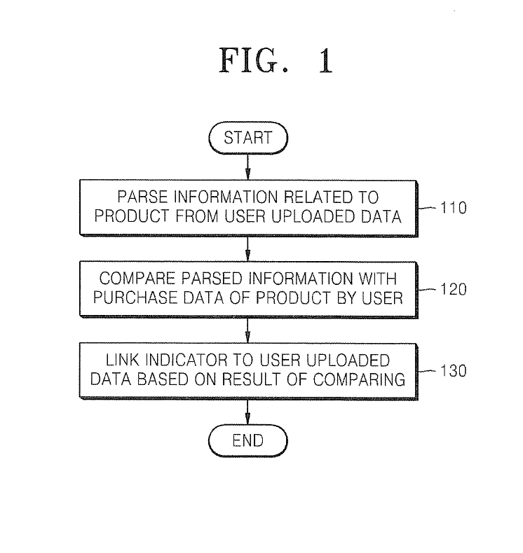

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged processing terminals. Hereinafter, exemplary embodiments of the present invention will now be described with reference to the accompanying drawings.

FIG. 1 illustrates an example method of managing user purchase information according to an embodiment of the present invention.

Referring to FIG. 1, an apparatus for managing user purchase information extracts or parses information associated with a product from data uploaded by users, in operation 110. In the current embodiment of the present invention, the term ‘user uploaded data’ refers to data posted on a social network service (SNS) in which a user is a member. For example, if there is a word related to a product A in a posted comment, the apparatus extracts information about the ‘product A’. If the SNS is an external SNS connected to the apparatus via a network, the apparatus requests and receives the data uploaded by users from the SNS. On the other hand, if the apparatus serves the SNS, it directly extracts the user uploaded data.

In operation 120, the apparatus compares the extracted information related to the product with user purchase information associated with the product. The user purchase information associated with the product may have been previously received from an external device and stored in the apparatus. The user purchase information associated with the product refers to payment information associated with the product. The payment information about the product includes at least one of information associated with a purchaser, a purchased product, a purchase price, and a purchasing location, such as, an online shopping mall.

In operation 130, the apparatus links an indicator to the user uploaded data based on a result of the comparing. If the extracted information related to the product corresponds to the purchase information associated with the product, the apparatus links the indicator to the user uploaded data. In the current embodiment of the present invention, the indicator refers to an interface related to purchasing the product. For example, the apparatus displays the purchase information associated with the product, or provides a button linked to a purchasing location to purchase the product or a search interface for searching for the purchase information associated with the product.

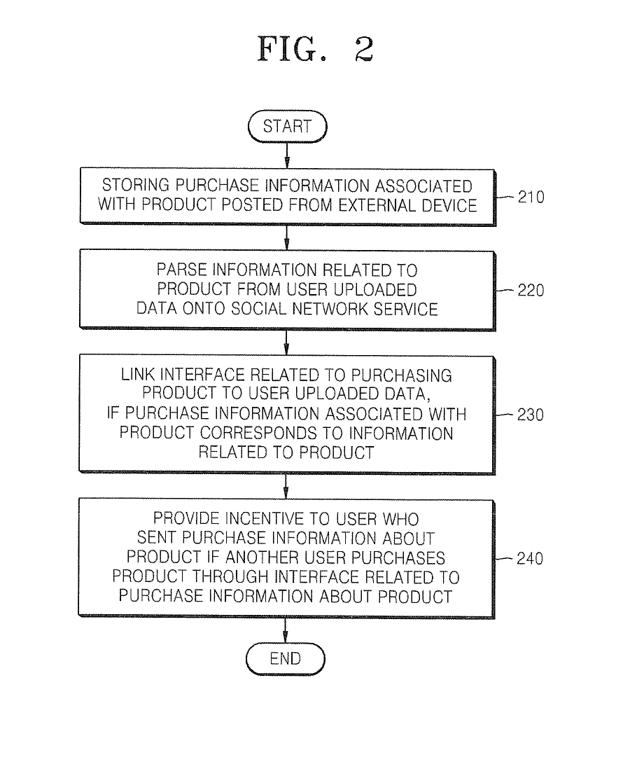

FIG. 2 illustrates an example method of managing user purchase information according to another embodiment of the present invention.

Referring to FIG. 2, in operation 210, an apparatus for managing user purchase information stores purchase information associated with a product, which is posted by an external device. The purchase information may include payment information. User purchase information associated with a product in certain embodiments, may refer to payment information associated with the product. The payment information associated with the product includes at least one of information associated with a purchaser, a purchased product, a purchase price, and a purchasing location, such as, an online shopping mall. The external device may be user equipment, such as a mobile phone or a personal computer (PC). The purchase information associated with the product may be the payment information associated with the product that has been automatically stored in the user equipment after paying for the product, or has been inputted by a user. In another embodiment, the external device may be a third party server related to a location where the product was purchased. In another embodiment, the external device may be a server such as a credit card company server related to a payment means such as a credit card used to purchase the product that checks the payment information. In an embodiment, if a product is purchased via the apparatus, the apparatus may store the purchase information associated with the product therein.

In operation 220, the apparatus may extract information related to a product from user uploaded data on an SNS. In one embodiment, user uploaded data refers to data posted on the SNS in which the user is a member. If the SNS is an external SNS connected to the apparatus via a network, the apparatus requests and receives from the SNS the user uploaded data. On the other hand, if the apparatus serves the SNS, it directly extracts the user uploaded data. For the external SNS, an application program interface (API) for an existing SNS maybe used, or a separate SNS may be implemented.

In operation 230, the apparatus compares the extracted information related to the product with the purchase information associated with the product, and then links an indicator related to purchasing the product to the user uploaded data. In one embodiment, the indicator refers to an interface related to purchasing the product. For example, the apparatus displays the purchase information associated with the product, or provides a button linked to a purchasing location related to the product, for the user uploaded data. Then another user may see the purchase information associated with the product, or may use the button to purchase the product at the purchasing location. Otherwise, the apparatus may provide a search interface for searching for the purchase information associated with the product.

In operation 240, the apparatus may offer a reward to a user who sent the purchase information associated with the product if another user purchases the product using the interface associated with the purchase information associated with the product. The reward may be cyber money such as points, or real cash.

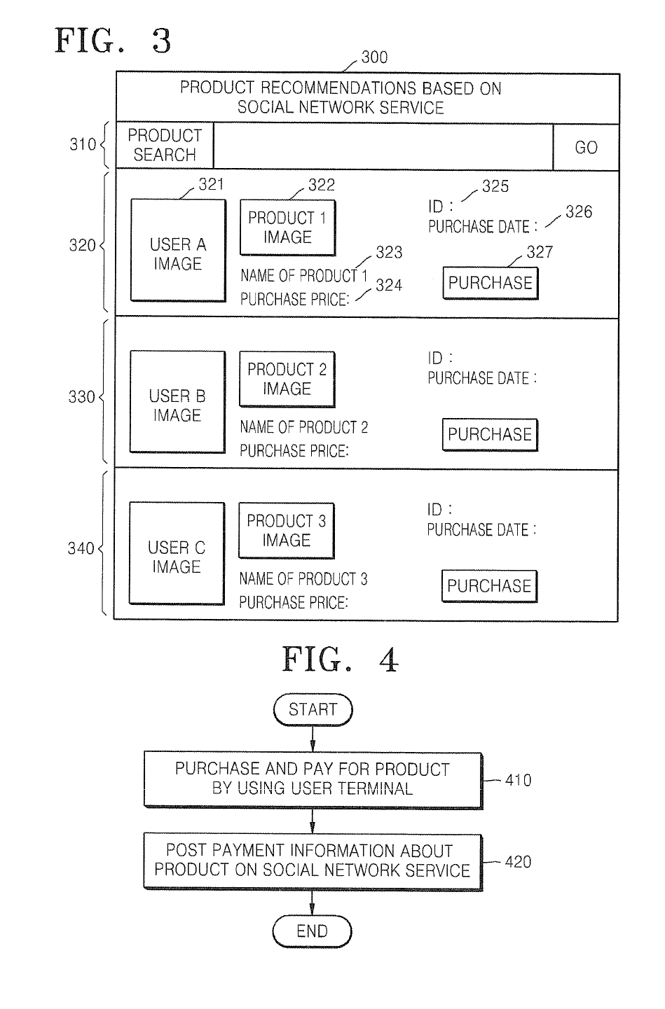

FIG. 3 illustrates an interface related to the purchase information associated with the product, according to an embodiment of the present invention.

Referring to FIG. 3, in the interface 300, posted purchase information associated with products 320, 330, and 340 are displayed, and a search window 310 is provided for searching for goods related to the purchase information associated with the product. The posted purchase information associated with the product 320 includes information associated with a user 321 and associated identification (ID) 325 who purchased the product, a product image 322, a product name 323, a purchase price 324, a purchase date 326, and a purchasing button 327 linked to a purchasing location.

FIG. 4 illustrates an example method of providing user purchase information according to an embodiment of the present invention.

Referring to FIG. 4, an apparatus for providing user purchase information performs operations of purchasing and paying for a product, in operation 410. For example, payment for the product may be made via the apparatus to an e-commerce site, such as an online shopping mall, by using a credit card.

In operation 420, the apparatus extracts payment information associated with the product, and posts the payment information to an SNS of which a user who purchased the product is a member. For the SNS, an API for an existing SNS may be used, or a separate SNS may be implemented.

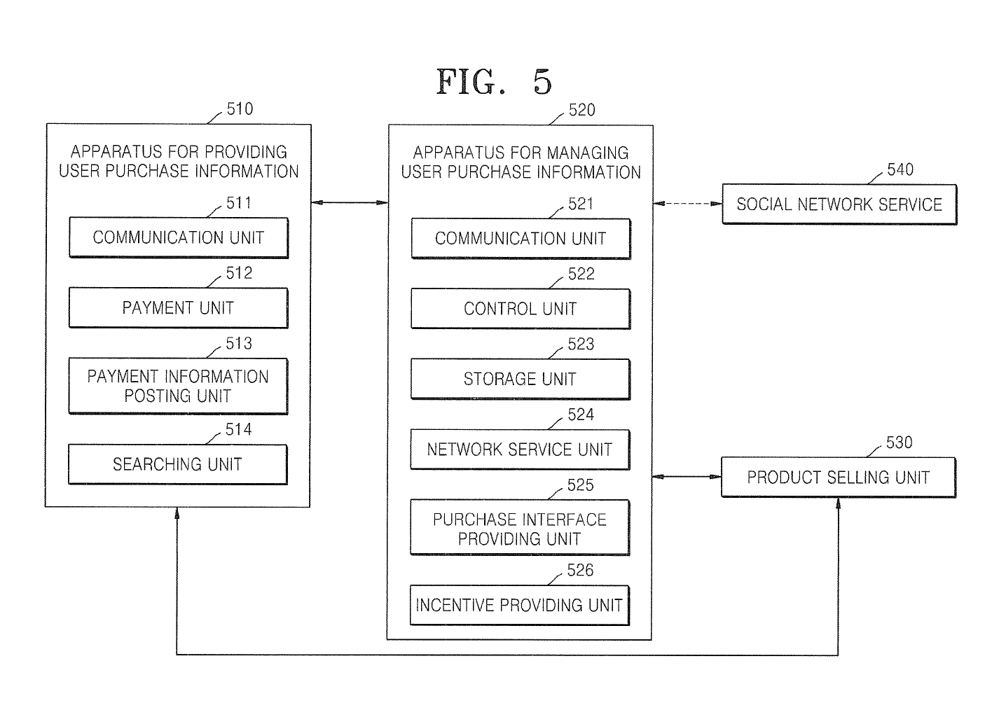

FIG. 5 illustrates an example system 500 for managing user purchase information according to an embodiment of the present invention.

Referring to FIG. 5, the system 500 includes an apparatus for providing user purchase information 510, an apparatus for managing user purchase information 520, a product selling server 530, and an SNS 540. The apparatus for providing user purchase information 510 includes a communication unit 511, a payment unit 512, a payment information posting unit 513, and a searching unit 514. The apparatus for managing user purchase information 520 includes a communication unit 521, a control unit 522, a storage unit 523, a network service unit 524, a purchase interface providing unit 525, and a incentive providing unit 526. The apparatus for providing user purchase information 510 is coupled to the apparatus for managing user purchase information 520 and the product selling server 530. The apparatus for managing user purchase information 520 is coupled to the apparatus for providing user purchase information 510, the goods selling server 530, and the SNS 540. In another embodiment, the apparatus for providing user purchase information 510 may also be coupled to the SNS 540. The apparatuses for providing and managing user purchase information 510 and 520 may be implemented in a single module or in multiple modules.

The communication unit 521 of the apparatus for managing user purchase information 520 receives purchase information associated with the product from the apparatus for providing user purchase information 510. The control unit 522 stores the received purchase information associated with the product in the storage unit 523. In one embodiment, the purchase information about the product may refer to payment information. User purchase information about the product refers to payment information about the product. The payment information associated with the product includes at least one of information associated with a purchaser, a purchased product, a purchase price, and a location where the product is purchased, such as an online shopping mall. The payment unit 512 of the apparatus for providing user purchase information 510 provides a payment function for a product to be purchased. For example, payment for a product maybe made via the payment unit 512 to an e-commerce site, such as, an online shopping mall, by using a credit card. After that, the payment information posting unit 513 receives required information, such as payment information from the payment unit 512, and sends the payment information to the apparatus for managing user purchase information 520 through the communication unit 511. In another embodiment, the communication unit 521 of the apparatus for managing user purchase information 520 may receive the information from an external device other than the apparatus for providing user purchase information 510. The apparatus for providing user purchase information 510 may also receive the payment information from the product selling server 530 from which the product was purchased. In another embodiment, the payment information may be received from a server, such as, for example, a credit card company server associated with a payment means, such as, for example, a credit card that was used to purchase the product by the user of the apparatus for providing user purchase information 510. In an embodiment, when the user purchases the product by using the apparatus for managing user purchase information 520, the purchase information about the product may be stored in the apparatus for managing user purchase information 520.

In another embodiment, the payment information posting unit 513 may extract the payment information associated with a product, and post the payment information on the SNS 540 of which the user who purchased the product is a member.

The control unit 522 extracts or parses the information related to a product from data uploaded by users. In an embodiment, the user uploaded data refers to data posted on a social network service (SNS) in which the users are members. For example, if there is a word related to a product A in a posted comment, the apparatus for managing user purchase information 520 extracts information associated with the ‘product A’, which is product-related information. In this case, the control unit 522 requests and receives from the SNS 540 the user uploaded data. For the SNS 540, an API for an existing SNS, or a separate SNS maybe implemented. In another embodiment, in the case where the apparatus for managing user purchase information serves the social network service, the control unit 522 may extract user data posted on the network service unit 524.

The control unit 522 compares the extracted information related to the product with user purchase information associated with the product. After the comparison, the controller 522 links an indicator related to purchasing the product to the user uploaded data if the extracted information related to the product and the purchase information associated with the product are identical. In an embodiment, the indicator refers to an interface related to purchasing the product. In other words, if the extracted information related to the product is identical to the purchase information associated with the product, the control unit 522 instructs the purchase interface providing unit 525 to provide the interface. The purchase interface providing unit 525 displays the purchase information associated with the product, or provides a button linked to a location where the product was purchased, for the user uploaded data. In this manner, other users may see the purchase information associated with the product for the user uploaded data, or may use the button to purchase the product at the purchasing location. Otherwise, the purchase interface providing unit 525 may provide a search interface for searching for the purchase information associated with the product.

The incentive providing unit 525 offers a reward to a user who sent the purchase information associated with the product if another user purchases the product using the interface related to the purchase information associated with the product. The reward may include cyber money such as points, or real cash.

According to certain embodiments, the method and apparatus for managing and providing user purchase information, purchasers may obtain trustworthy purchase information from posted purchase information and sellers may also enjoy an advertising effect without special advertising activities because advertisement is facilitated through social network services.

A program for carrying out exemplary embodiments of the present invention may be implemented as computer readable codes on a computer readable storage medium. Examples of the computer readable storage medium include all kinds of storage devices which can be read by a computer system. The computer readable storage medium comprises, for example, a read only memory (ROM), random access memory (RAM), compact disk-ROM (CD-ROM), magnetic tape, floppy disk, optical data storage device, and so like. The computer readable storage medium can also be distributed to a computer system connected to a network to be stored and executed as computer readable program codes.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of managing user purchase information, the method comprising:
extracting the purchase information related to a product from a user uploaded data;
comparing the extracted information with a purchase data of the product by a user; and
linking an indicator to the user uploaded data according to the comparison.

2. The method of claim 1, wherein the purchase information associated with the product comprises payment information associated with the product.

3. The method of claim 2, wherein the payment information comprises at least one of information associated with a purchaser, a purchased product, a purchase price, and a location where the product is purchased.

4. The method of claim 1, further comprising,
storing the purchase information associated with the product, the purchase information being posted by an external device.

5. The method of claim 4, wherein the external device comprises user equipment that is used to purchase the product.

6. The method of claim 4, wherein the external device comprises a server associated with a payment means that is used to purchase the product.

7. The method of claim 4, wherein the external device comprises a server associated with a location where the product was purchased.

8. The method of claim 1, wherein the user uploaded data comprises data uploaded onto a social network service (SNS) in which the user is a member.

9. The method of claim 4, wherein linking the indicator to the user uploaded data based on the result of the comparing, comprises linking an interface related to purchasing the product to the user uploaded data if the information related to the product corresponds to the purchase information about the product.

10. The method of claim 9, wherein the linking of the interface related to purchasing the product to the user uploaded data comprises displaying the posted purchase information associated with the product.

11. The method of claim 9, wherein linking the interface related to purchasing the product to the user uploaded data, comprises linking an interface for searching for the posted purchase information associated with the product to the user uploaded data.

12. The method of claim 1, further comprising,
if another user purchases the product using the indicator, providing an incentive to a user with user uploaded data to be linked to the indicator.

13. A method of providing user purchase data in a user equipment, the method comprising,
purchasing and paying for a product by using the user equipment; and
posting payment information about the product on a social networking service (SNS).

14. The method of claim 13, wherein the payment information about the product includes at least one of information associated with a purchaser, a purchased product, a purchase price, and a location where the product is purchased.

15. The method of claim 13, further comprising,
receiving reward information from an external device if anot her user purchases the product based on the payment information.

16. An apparatus for managing user purchase information, the apparatus comprising:
a storage unit configured to store purchase information associated with a product; and
a control unit configured to extract information related to the product from a user uploaded data, compare the extracted information with a purchase data of the product by the user, and link an indicator to the user uploaded data according to the comparison.

17. The apparatus of claim 16, wherein the purchase information associated with the product comprises payment information about the product.

18. The apparatus of claim 17, wherein the payment information comprises at least one of information associated with a purchaser, a purchased product, a purchase price, and a location where the product is purchased.

19. The apparatus of claim 16, further comprising,
a communication unit configured to receive the purchase information associated with the product from an external device.

20. The apparatus of claim 19, wherein the external device comprises user equipment that is used to purchase the product.

21. The apparatus of claim 19, wherein the external device comprises a server associated with a payment means that is used to purchase the product.

22. The apparatus of claim 19, wherein the external device comprises a server associated with a location where the product is purchased.

23. The apparatus of claim 16, wherein the user uploaded data comprises data uploaded onto a social network service (SNS) in which the user is a member.

24. The apparatus of claim 19, further comprising,
a purchase interface providing unit configured to provide an interface related to purchasing the product,
wherein the control unit is configured to link the interface to the user uploaded data if the information related to the prod uct and the purchase information associated with the product are identical.

25. The apparatus of claim 24, wherein the purchase interfa ce providing unit is configured to display the posted purchase in formation associated with the product.

26. The apparatus of claim 24, wherein the purchase interface providing unit is configured to provide an interface for searching for the posted purchase information associated with the posted product.

27. The apparatus of claim 16, further comprising,
A incentive providing unit configured to offer a reward to the user with user uploaded data to be linked to the indicator if another user purchases the product using the indicator.

28. An apparatus for providing user purchase data in user equipment, the apparatus comprising,
a payment unit configured to purchase pay for a product by using the user equipment; and
a payment information posting unit configured to post payment information associated with the product on a social networking service (SNS).

29. The apparatus of claim 28, wherein the payment information associated with the product includes at least one of information associated with a purchaser, a purchased product, a purchase price, and a location where the product is purchased.

30. The apparatus of claim 28, further comprising,
a communication unit configured to receive reward information from an external device if another user purchases the product based on the payment information.
